(19) United States
(12) Patent Application Publication
(10) Pub. No.: US 2019/0056065 A1
(43) Pub. Date: Feb. 21, 2019

(54) PALLET FOR CYLINDERS, METHOD FOR ARRANGING CYLINDERS IN A PALLET, AND PALLET WITH CYLINDERS

(71) Applicant: Konstantin Vladimirovich SOROKIN, Moscow (RU)

(72) Inventors: Oleg Stanislavovich KLUNIN, Vsevolozhskiy raion (RU); Oleg Evgenievich BOGACHEK, Saint Petersburg (RU)

(21) Appl. No.: 15/765,117

(22) PCT Filed: Sep. 30, 2016
(86) PCT No.: PCT/RU2016/000656

§ 371 Date: Mar. 30, 2018

(30) Foreign Application Priority Data
Oct. 1, 2015 (RU) 2015141773

(51) Int. Cl. F17C 13/08; F17C 13/02

(52) U.S. Cl. CPC F17C 13/084; F17C 13/025; F17C 2205/0107; F17C 2205/0352; F17C 2205/0157; F17C 2250/043; F17C 2201/0109; F17C 2221/033; F17C 2205/0138; F17C 2201/054

(57) ABSTRACT

The invention relates to the field of transportation and storage of gas cylinders, and specifically to a container for gas cylinders, in particular, cylinders for pressurized or liquefied gas, a method for arranging gas cylinders in the container, in particular, cylinders for pressurized or liquefied gas, and a container with gas cylinders, in particular, cylinders for pressurized or liquefied gas. The container for gas cylinders comprises a housing and at least one pipeline positioned to be connected with the gas cylinders in the lower part of the framework. The method comprises arranging the gas cylinders in a framework of the container; and connecting at least one pipeline with the gas cylinders in a lower part of the framework. The container with gas cylinders comprises a framework; at least one gas cylinder; and at least one pipeline connected with the at least one gas cylinder in a lower part of the framework. The technical effect involves simplification and expediting of the removal of condensate and impurities from the gas cylinders during handling the container containing the gas cylinders, in particular, the gas cylinders for natural gas. The additional technical effect is the reduction of the amount of condensate and impurities in the gas cylinders, in particular, the gas cylinders for natural gas, during handling the container containing the gas cylinders, in particular, the gas cylinders for natural gas.

### TECHNICAL FIELD

The present invention relates to the field of transportation and storage of gas cylinders, and specifically to a container for gas cylinders, in particular, cylinders for pressurized or liquefied gas, to a method for arranging gas cylinders in the container, in particular, cylinders for pressurized or liquefied gas, and to a container with the gas cylinders, in particular, cylinders for pressurized or liquefied gas.

### BACKGROUND

Well known containers for gas cylinders are intended for gas injection into the cylinders arranged in a container, gas storage in the cylinders, gas transportation in the cylinders, and gas dispensing from the cylinders to consumers.

An example of such a container for gas cylinders is described in CN2425051. The container comprises a housing, a cluster of gas cylinders in a vertical position, a securing support, a pipeline for gas supply, and a conveying pipe located in an upper part of the container. In such a container, the gas cylinders are mounted in the container housing and the pipeline for gas supply and conveying pipe located are connected in the upper part of the housing.

During transportation and storage of cylinders for pressurized gas, a condensate is usually formed in the cylinders due to moisture contained in gas injected in the gas cylinders. Moreover, the gas supplied to a manufacturing facilities and consumers generally contains impurities which also get into a gas cylinder. The condensate formation and gas impurities getting into a gas cylinder negatively affect the gas cylinder operation performance as the effective gas cylinder capacity for gas accommodation decreases due to its partial substitution with the condensate while impurities can have an aggressive effect on the materials of the gas cylinder inner shells. To remove condensate and impurities from a gas cylinder, its recurrent emptying is required that is an inconvenient process which interrupts the major process of handling the gas cylinders containing gas and placed in a container.

Disadvantageously, the top location of the known system for gas injection into gas cylinders and gas dispensing from the gas cylinders requires recurrent using an auxiliary equipment and/or additional operations for removing condensate and impurities from the gas cylinders.

Thus, there is a need to create a container for gas cylinders, a method for arranging gas cylinders in the container and a container with the gas cylinders which would eliminate the need for additional operations and using an auxiliary equipment for removing condensate and impurities from the gas cylinder.

### SUMMARY

The aim of the present invention is to create a container for gas cylinders, a method for arranging gas cylinders in the container and a container with the gas cylinders allowing to ease transportation and storage of gas cylinders in the container by eliminating the need for additional operations for removing condensate and impurities from the gas cylinders without using an auxiliary equipment.

The aim is achieved by a container for gas cylinders, the container comprising a housing and at least one pipeline positioned to be connected with the gas cylinders in a lower part of the framework. Further, the aim is achieved by a method for arranging gas cylinders in the container, the method comprising the steps of arranging the gas cylinders in a framework of the container; and connecting at least one pipeline is with the gas cylinders in a lower part of the framework. Further, the aim is achieved by a container with the gas cylinders, the container comprising a framework; at least one gas cylinder; and at least one pipeline connected with the at least one gas cylinder in a lower part of the framework.

The container for gas cylinders, the method for arranging gas cylinders in the container and the container with gas cylinders simplify and expedite removal of condensate and impurities from the gas cylinders during handling the container containing the gas cylinders, in particular, the gas cylinders for natural gas. The additional technical effect is the reduction of the amount of condensate and impurities in gas cylinders, in particular, gas cylinders for natural gas, during handling the container containing the gas cylinders, in particular, the gas cylinders for natural gas.

The technical effects are achieved owing to the pipelines connected with the gas cylinders in the lower part of the container framework which allow to perform recurrent removal of condensate and impurities from the gas cylinders in the lower part of the container framework under excess pressure in the gas cylinders, thus eliminating the need for additional operations for removing condensate and impurities and using an auxiliary equipment for removing condensate and impurities from the gas cylinders.

Preferably, the container comprises means for fastening the gas cylinders to the framework.

Preferably, the at least one pipeline is connectable with the gas cylinders by means of at least one connection fitting.

In the prior art a stop valve is used for connection of a pipeline with a gas cylinder. In the present invention, using a connection fitting instead of a stop valve for connection of a pipeline with a gas cylinder provides the additional technical effect involving an increase in the length of a gas cylinder suitable for its arrangement in the container in a stand-up position and, consequently, an increase in the gas cylinder capacity. In the present specification, the length of a gas cylinder should be interpreted as the length of a gas cylinder without valves and fasteners mounted on its necks.

In another preferred embodiment, the means for fastening gas cylinders to the framework are configured to provide gas cylinders fastening to the upper part of the framework and/or the lower part of the framework.

In another preferred embodiment, the means for fastening gas cylinders to the framework comprise at least one recess configured to receive the gas cylinder in a stand-up position, thus restricting mobility of a lower part of the gas cylinder relative to the container.

Receiving the gas cylinder in the recess provides secure gas cylinder fastening to the framework to provide safe transportation of the gas cylinder in the container.

In another preferred embodiment, the recess is a dome-shaped bowl with a centering hole.

In another preferred embodiment, the means for fastening gas cylinders to the framework comprise at least one insert located in the lower part of the framework and/or the upper part of the framework.

In another preferred embodiment, the means for fastening gas cylinders to the framework comprise at least one nut configured for being mounted on a gas cylinder neck.

In another preferred embodiment, the means for fastening gas cylinders to the framework are configured to fasten the gas cylinders to the upper part of the framework, thus providing mobility of upper parts of the gas cylinders relative to the container.

In another preferred embodiment, the means for fastening gas cylinders to the framework are configured to fasten the gas cylinders in a stand-up position in a checkerboard pattern.

In another preferred embodiment, the container has a length from 2,986 mm to 2,991 mm, width from 2,433 mm to 2,438 mm and height from 2,891 mm to 2,896 mm.

In another preferred embodiment, the container has the length from 6,052 mm to 6,058 mm, a width from 2,433 mm to 2,438 mm and a height from 2,891 mm to 2,896 mm.

In another preferred embodiment, the container has a length from 9,115 mm to 9,125 mm, a width from 2,433 mm to 2,438 mm and a height from 2,891 mm to 2,896 mm.

It should be noted that any reference in the present specification to a quantity value range means that all the values of the respective quantity including the boundary values are within the range.

In another preferred embodiment, the framework is a metal load-bearing framework.

In another preferred embodiment, the container comprises means for controlling at least one pipeline? the means comprising at least one pressure gauge.

In another preferred embodiment, the gas cylinders are arranged in the container framework in a stand-up position in a checkerboard pattern.

Arranging gas cylinders in the framework in a stand-up position in a checkerboard pattern provides an increased container capacity for the gas cylinders providing the latter are arranged in the container. In the present specification, the capacity of a container should be interpreted as the integral capacity of the gas cylinders contained therein.

In another preferred embodiment, the gas cylinders are fastened to the framework.

In another preferred embodiment, the gas cylinders are fastened to an upper part of the framework and/or the lower part of the framework.

In another preferred embodiment, at least one gas cylinder in a stand-up position is fastened to the lower part of the framework by its insertion into a recess configured as a dome-shaped bowl with a centering hole, thus restricting mobility of a lower part of the gas cylinder relative to the container.

In another preferred embodiment, at least one gas cylinder in a stand-up position is fastened to the upper part of the framework, thus providing mobility of an upper part of the gas cylinders relative to the container.

In another preferred embodiment, at least one gas cylinder is fastened to the lower part of the framework by fastening the gas cylinder neck to the container framework using a nut mounted on a gas cylinder neck, thus restricting mobility of a lower part of the gas cylinder relative to the container.

In another preferred embodiment, the at least one gas cylinder is a gas cylinder for natural gas.

In another preferred embodiment, the at least one gas cylinder is a gas cylinder for pressurized or liquefied gas.

In another preferred embodiment, the at least one gas cylinder is fastened to the framework.

In another preferred embodiment, the at least one gas cylinder is fastened to an upper part of the framework and/or the lower part of the framework.

In another preferred embodiment, fastening of the at least one gas cylinder to the lower part of the framework is provided by insertion of the at least one gas cylinder in a stand-up position into a recess configured as a dome-shaped bowl with a centering hole, thus restricting mobility of a lower part of the gas cylinder relative to the container.

In another preferred embodiment, fastening of the at least one gas cylinder to the lower part of the framework is provided by fastening the gas cylinder neck to the container framework using a nut mounted on the gas cylinder neck, thus restricting mobility of a lower part of the gas cylinder relative to the container.

In another preferred embodiment, the at least one gas cylinder in a stand-up position is fastened to the upper part of the framework, thus providing mobility of an upper part of the gas cylinders relative to the container.

In another preferred embodiment, the at least one gas cylinder comprises at least one neck and a connection fitting mounted on the at least one neck and connectable with the at least one pipeline.

In another preferred embodiment, the at least one gas cylinder comprises at least one safety valve.

In another preferred embodiment, the container comprises means for controlling at least one pipeline, the means comprising at least one pressure gauge and/or at least one control valve.

The means for fastening gas cylinders to the framework and control means provide secure and safe handling the gas cylinders placed in the container.

### POSITIONAL NUMBERS

1—container;
2—gas cylinders;
3—framework;
4—pipelines;
5—pressure gauges.

### BRIEF DESCRIPTION OF THE FIGURES

FIG. 1 shows a schematic bottom view of a container for gas cylinders according to a preferred embodiment of the present invention.

FIG. 2 shows a schematic top view, a side view and two end views of a container for gas cylinders according to a preferred embodiment of the present invention.

### DETAILED DESCRIPTION OF THE EMBODIMENTS

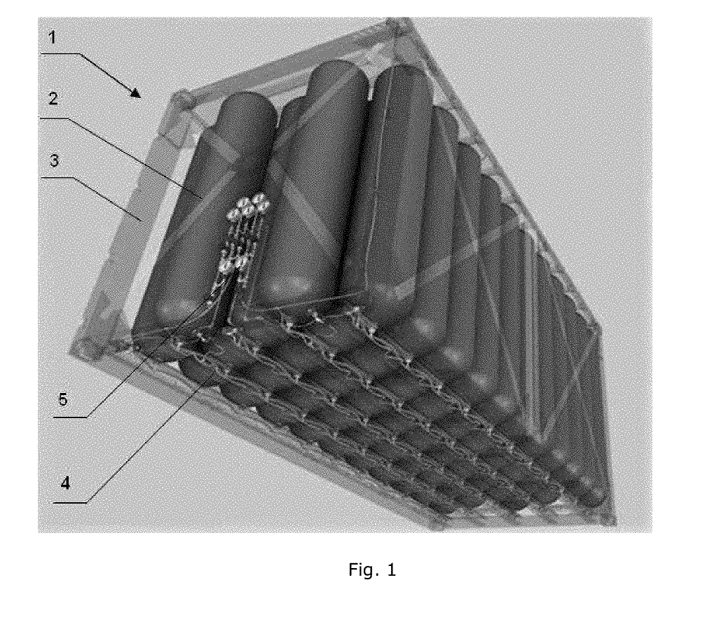

FIG. 1 shows a schematic bottom view of a container for gas cylinders according to a preferred embodiment of the present invention.

The container 1 is intended for transportation and storage of gas cylinders 2 which can be arranged in the framework 3 of the container 1.

Preferably, the framework 3 is a metal load-bearing framework composed of metal beams, however, it can be composed of any other elements suitable for arrangement inside the framework 3 of the gas cylinders 2 which provide a sufficient security and safety of the container 1 structure during its transportation, if required.

According to an embodiment of the present invention, the gas cylinders 2 are gas cylinders for pressurized gas. Preferably, the cylinders 2 are gas cylinders for pressurized gas, in particular, gas cylinders for compressed natural gas which physical and chemical properties comply with GOST 27577-2000. According to the present invention, the gas cylinders 2 can also be used for other pressurized or liquefied gases which do not have an aggressive effect on the materials of the gas cylinder impermeable and/or load-bearing shells, if required. The gases which can be put into the gas cylinders 2, according to the present invention, are not limited to those listed above.

Preferably, the container 1 for gas cylinders 2 has the length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009). Preferably, each of the gas cylinders 2 has the outer diameter ranged from 480 mm to 520 mm, capacity ranged from 350 l to 430 l, at least one shell (not shown) with the length ranged from 2,400 mm to 2,870 mm, inner diameter at least 420 mm and outer diameter not more than 520 mm.

The container 1 for gas cylinders 2 also comprises five pipelines 4 located in the lower part of the framework 3. It should be noted that the quantity of the pipelines 4 is not limiting in the present invention and can be selected depending on the requirements and the quantity of the gas cylinders placed in the container 1 and/or gas cylinders which need to be connected with the pipelines.

The pipelines 4 are connected with the gas cylinders 2 in the lower part of the framework using connection fittings (not shown) mounted on the necks of the gas cylinders 2.

In other non-restrictive embodiments, the pipelines 4 can be connected with the gas cylinders 2 by means of any suitable method using any suitable connection means.

Preferably, the pipelines 4 can be welded to connection fittings mounted on the necks of the gas cylinders 2 or connected with the connection fittings by means of another suitable method.

Each of the gas cylinders 2 can comprise only one neck or more necks, if required. Depending on the application different stop and/or safety valves can be mounted on the necks of the gas cylinders 2 without limitation, including fire safety valves.

The container 1 optionally comprises means for controlling the pipelines 4 mounted on the end face of the container 1 and comprising pressure gauges 5 for each of the pipelines 4.

The means for controlling the pipelines 4 can be located in any suitable part of the container 1.

The means for controlling the pipelines 4 can be any suitable control means without limitation.

The means for controlling the pipelines 4 comprise also at least one control valve configured to be opened for gas injection into the gas cylinders 2, gas supply from the gas cylinders 2 and removal of condensate and impurities from the gas cylinder, and closed after these procedures. The control valve can be located close to the other control means, for example, pressure gauges 5 on the end face of the container 1, or it can be located at a distance from the other control means in the other part of the container 1. Gas injection into the gas cylinders and/or gas supply from the gas cylinders 2 can be preformed using other control valves or other means located in any suitable part of the container 1.

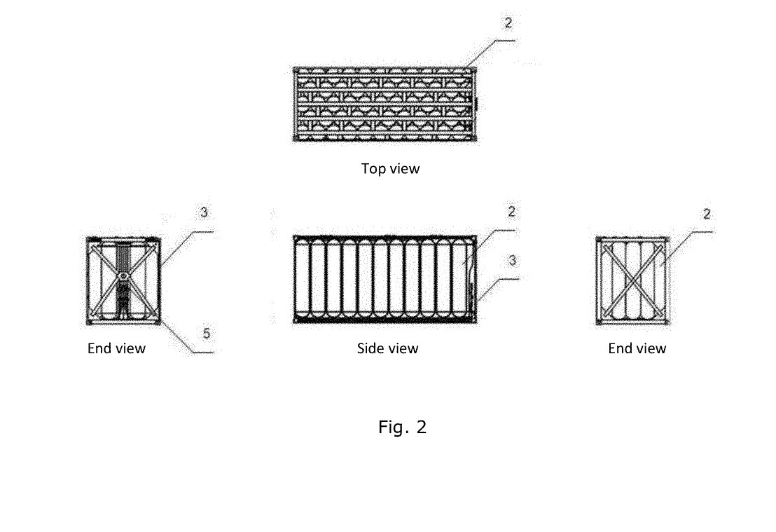

FIG. 2 shows a schematic top view and two end views of the container 1 for gas cylinders 2 according to a preferred embodiment of the present invention.

As shown in FIG. 2, the gas cylinders 2 are arranged in the container 1 in a stand-up position in a checkerboard pattern; however, this arrangement of the gas cylinders 2 in the container 1 is not a restrictive and represents an example of the most preferred arrangement of the gas cylinders 2 which provides the optimal value of the container 1 capacity.

The container 1 also comprises means for fastening of the gas cylinders 2 to the framework 3 which preferably are located in the upper part of the framework 3 and the lower part of the framework 3.

The means for fastening of the gas cylinders 2 to the framework 3 can be any suitable fastening means for fastening of the gas cylinders 2 to the framework 3.

In an embodiment of the invention, the means for fastening of the gas cylinders 2 to the framework 3 comprise recesses configured as a dome-shaped bowl with a centering hole located in the lower part of the framework 3 for insertion of the gas cylinders 2 in a stand-up position into them, thus restricting mobility of a lower part of the gas cylinders 2 relative to the container.

The dome-shaped bowls are welded to the lower part of the framework 3 in the locations corresponding to the positions of the gas cylinders 2 in the framework 3. The dome-shaped bowls are configured in such a manner that when inserting the gas cylinders 2 into them the latter are fastened inside a bowl through a close contact between the outer surface of the gas cylinders 2 and the inner surface of the bowl due to the gradual decrease in the bowl inner diameter in the direction from the top part of the bowl to the bottom part of the bowl and presence of the centering hole. Such fastening of the gas cylinders 2 in a bowl restricts mobility of the lower part of the gas cylinders 2. The bowl can comprise damping elements of elastic material, if required.

In another embodiment, the means for fastening the gas cylinders 2 to the framework 3 can comprise inserts capturing the upper and/or the lower parts of the gas cylinders or threaded nuts mounted on the necks in the lower parts of the gas cylinders 2 and channels to which the inserts and/or threaded nuts are fastened. In particular, the necks of the gas cylinders 2 can be fastened to the channels using the inserts mounted on the necks of the gas cylinders and inserted into the corresponding holes in the channels. The channels, in turn, are fastened (for example, welded) to the framework 3.

The means for fastening of the gas cylinders 2 to the framework 3 can comprise means which provide mobility of the upper (relative to the container) parts of the gas cylinders 2. In particular, mobility of the upper (relative to the container) parts of the gas cylinders 2 can be provided by using, for example, spacers of elastic material. Such a spacer is placed, for example, between the gas cylinder 2 and an insert or between the gas cylinder 2 and the hole in the channel in which the insert is inserted capturing the upper part of the gas cylinder 2 and which inner diameter is greater than the outer diameter of the upper part of the gas cylinder 2. Elasticity of the spacer provides mobility of the upper (relative to the container 1) parts of the gas cylinders 2 within the insert capture limits.

The means for fastening of the gas cylinders 2 to the framework 3 can comprise any suitable fastening means located in any suitable part of the framework 3, if required.

A method for arranging gas cylinders 2 in the container 1 according to a preferred embodiment is described below.

Preferably, the method for arranging the gas cylinders 2 in the container 1 is performed as follows:
the gas cylinders 2 are arranged in a stand-up position in a checkerboard pattern in the framework 3 of the container 1; and
the pipelines 4 are connected with the gas cylinders 2 in the lower part of the framework 3.

The gas cylinders 2 are fastened to the lower part of the framework 3 and/or the upper part of the framework 3 using fastening means, if required.

In another preferred embodiment, the method for arranging gas cylinders 2 in the container 1 is performed as follows:
the gas cylinders 2 are arranged in the framework 3 of the container 1 by inserting the gas cylinders 2 in a stand-up position in a checkerboard pattern into recesses configured as dome-shaped bowls with centering holes, thus restricting mobility of the lower part of the gas cylinders 2 relative to the container through a close contact between an outer surface of the gas cylinders 2 and an inner surface of the bowl due to the gradual decrease in the bowl inner diameter in the direction from the top part of the bowl to the bottom part of the bowl and presence of the centering hole,
the gas cylinders 2 are fastened to the upper part of the framework 3 of the container 1 using inserts capturing a gas cylinder and mounted on the necks of the gas cylinders 2. The inserts are inserted into the corresponding holes in channels which, in turn, are fastened to the framework 3. The inserts with the inner diameter greater than the outer diameter of the upper part of the gas cylinder 2 can be used and a spacer of elastic material can be placed between the inserts and gas cylinders 2, thus providing mobility of the upper part of the gas cylinders 2 relative to the container 1, if required, and
the pipelines 4 are connected with the gas cylinders 2 in the lower part of the framework 3 by welding of connection fittings mounted on the necks of the gas cylinders to the pipelines 4.

When the gas cylinders 2 are arranged in the container 1 the container 1 with the gas cylinders 2 into which gas injection is performed and from which gas supply is performed using the required means implemented in the art is ready for further operation. Control of the procedures is provided using pressure gauges and/or other suitable devices.

To remove condensate and impurities from the gas cylinders 2 in the time when it is needed, for example, prior to gas injection in the gas cylinders 2 and/or gas supply from the gas cylinders 2, condensate and impurities are discharged from the gas cylinders 2 under pressure in the gas cylinders 2 through the pipelines 4 connected with the gas cylinders 2 in the lower part of the framework 3. To discharge condensate and impurities from the gas cylinders 2, the control valve is opened. The valve is closed, when discharge is finished. Thus, to remove condensate and impurities from the gas cylinders 2, no auxiliary equipment, additional time and labour contribution are required.

It should be noted that the described container with gas cylinders and the method for arranging gas cylinders in the container are just some of the preferred embodiments. It is obvious for one skilled in the art that in the present invention variations and modifications can be introduced without deviation from the scope of the invention as defined by the claims below.

1. A container for gas cylinders, the container comprising a framework and at least one pipeline positioned to be connected with the gas cylinders in a lower part of the framework.

2. The container of claim 1, wherein the container comprises means for fastening the gas cylinders to the framework.

3. The container of claim 1, wherein the at least one pipeline is connectable with the gas cylinders by means of at least one connection fitting.

4. The container of claim 2, wherein the means for fastening gas cylinders to the framework are configured to fasten the gas cylinders to an upper part of the framework and/or the lower part of the framework.

5. The container of claim 2, wherein the means for fastening gas cylinders to the framework comprise at least one recess configured to receive the gas cylinder in a stand-up position, thus restricting mobility of a lower part of the gas cylinder relative to the container.

6. The container of claim 5, wherein the recess is a dome-shaped bowl with a centering hole.

7. The container of claim 2, wherein the means for fastening gas cylinders to the framework comprise at least one insert located in the lower part of the framework and/or the upper part of the framework.

8. The container of claim 2, wherein the means for fastening gas cylinders to the framework comprise at least one nut configured for being mounted on a gas cylinder neck.

9. The container of claim 2, wherein the means for fastening gas cylinders to the framework are configured to fasten the gas cylinders to the upper part of the framework, thus providing mobility of upper parts of the gas cylinders relative to the container.

10. The container of claim 2, wherein the means for fastening gas cylinders to the framework are configured to fasten the gas cylinders in a stand-up position in a checkerboard pattern.

11. The container of claim 1, wherein the container has a length from 2,986 mm to 2,991 mm, a width from 2,433 mm to 2,438 mm and a height from 2,891 mm to 2,896 mm.

12. The container of claim 1, wherein the container has a length from 6,052 mm to 6,058 mm, a width from 2,433 mm to 2,438 mm and a height from 2,891 mm to 2,896 mm.

13. The container of claim 1, wherein the container has a length from 9,115 mm to 9,125 mm, a width from 2,433 mm to 2,438 mm and a height from 2,891 mm to 2,896 mm.

14. The container of claim 1, wherein the framework is a metal load-bearing framework.

15. The container of claim 1, wherein the container comprises means for controlling at least one pipeline, the means comprising at least one pressure gauge.

16. A method for arranging gas cylinders in a container, the method comprising the steps of:
arranging the gas cylinders in a framework of the container; and
connecting at least one pipeline with the gas cylinders in a lower part of the framework.

17. The method of claim 16, wherein the gas cylinders are arranged in a stand-up position in a checkerboard pattern in the framework.

18. The method of claim 16, wherein the gas cylinders are fastened to the framework.

19. The method of claim 16, wherein the gas cylinders are fastened to an upper part of the framework and/or the lower part of the framework.

20. The method of claim 18, wherein at least one gas cylinder in a stand-up position is fastened to the lower part of the framework by its insertion into a recess configured as a dome-shaped bowl with a centering hole, thus restricting mobility of a lower part of the gas cylinder relative to the container.

21. The method of claim 18, wherein at least one gas cylinder in a stand-up position is fastened to the upper part of the framework, thus providing mobility of an upper part of the gas cylinders relative to the container.

22. The method of claim 18, wherein at least one gas cylinder is fastened to the lower part of the framework by fastening the gas cylinder neck to the container framework using a nut mounted on a gas cylinder neck, thus restricting mobility of a lower part of the gas cylinder relative to the container.

23. A container with gas cylinders, the container comprising:
a framework;
at least one gas cylinder arranged in the framework; and
at least one pipeline connected with the at least one gas cylinder in a lower part of the framework.

24. The container of claim 23, wherein the at least one gas cylinder is a gas cylinder for natural gas.

25. The container of claim 24, wherein the at least one gas cylinder is a gas cylinder for pressurized or liquefied gas.

26. The container of claim 23, wherein the at least one gas cylinder is fastened to the framework.

27. The container of claim 26, wherein the at least one gas cylinder is fastened to an upper part of the framework and/or the lower part of the framework.

28. The container of claim 26, wherein fastening of the at least one gas cylinder to the lower part of the framework is provided by insertion of the at least one gas cylinder in a stand-up position into a recess configured as a dome-shaped bowl with a centering hole, thus restricting mobility of a lower part of the gas cylinder relative to the container.

29. The container of claim 26, wherein fastening of the at least one gas cylinder to the lower part of the framework is provided by fastening the gas cylinder neck to the container framework using a nut mounted on the gas cylinder neck, thus restricting mobility of a lower part of the gas cylinder relative to the container.

30. The container of claim 26, wherein the at least one gas cylinder in a stand-up position is fastened to the upper part of the framework, thus providing mobility of an upper part of the gas cylinders relative to the container.

31. The container of claim 23, wherein the at least one gas cylinder comprises at least one neck and a connection fitting mounted on the at least one neck and connectable with the at least one pipeline.

32. The container of claim 23, wherein the at least one gas cylinder comprises at least one safety valve.

33. The container of claim 23, wherein the container comprises means for controlling at least one pipeline, the means comprising at least one pressure gauge and/or at least one control valve
